(19) United States
(12) Patent Application Publication
(10) Pub. No.: US 2012/0229397 A1
(43) Pub. Date: Sep. 13, 2012

(54) METHOD AND APPARATUS FOR SELECTING DESIRED CONTENTS ON READ TEXT IN PORTABLE TERMINAL

(75) Inventors: Woong-Suk CHO, Seoul (KR); Hyung-Ju LEE, Seongnam-si (KR); Pius LEE, Seongnam-si (KR)

(73) Assignee: Samsung Electronics Co., Ltd., Suwon-si (KR)

(21) Appl. No.: 13/413,317

(22) Filed: Mar. 6, 2012

(30) Foreign Application Priority Data
Mar. 8, 2011 (KR) 10-2011-0020285

(51) Int. Cl. G06F 3/041

(52) U.S. Cl. 345/173; 345/156

(57) ABSTRACT

A method and apparatus for easily setting desired contents within a text in a portable terminal is provided. The method includes determining a first position on a first row of the text, determining a second position on a second row of the text, and selecting contents located between the first position and the second position.

### PRIORITY

This application claims priority under 35 U.S.C. §119(a) to a Korean patent application filed in the Korean Intellectual Property Office on Mar. 8, 2011 and assigned Serial No. 10-2011-0020285, the entire content of which is incorporated herein by reference.

### BACKGROUND OF THE INVENTION

1. Field of the Invention

The present invention relates generally to a portable terminal, and more particularly, to a method and apparatus for selecting desired contents within a text.

2. Description of the Related Art

Portable terminals such as mobile terminals, electronic schedulers, and complex terminals have become necessities for many users, due at least in part to the development of electronic communication industries. The portable terminals have developed into important means of information transmission.

Portable terminals may be used to generate and/or provide a variety of documents (e.g., web pages, texts, etc).

Such a portable terminal may provide a function for specifying desired contents via a block indicating the desired contents, when a user of the portable terminal reads or writes a document. For example, while reading text, the user specifies desired contents within the text via a block before copying and storing the desired contents. For another example, when the user edits a text (such as by copying or deleting a part of the contents of the text or by changing the form of a letter or a paragraph), the user initially specifies desired contents via a block.

For example, a user may specify a block using a mouse, by dragging a mouse from a start part of contents to be set by a block to an end part of the contents to be set by the block while pushing a left button of the mouse, and then specifying the block. This method of specifying a block has a disadvantage in that, when the contents to be indicated by the block has a significant length, the user must drag the mouse for a long time in order to specify the block. Such a disadvantage is also present in touch screen terminals.

### SUMMARY OF THE INVENTION

An aspect of the present invention is to solve at least the above-mentioned problems and/or disadvantages and to provide at least the advantages described below. Accordingly, an aspect of the present invention is to provide a method and apparatus for easily selecting desired contents on a read text by a block in a portable terminal.

Another aspect of the present invention is to provide a method and apparatus for easily setting contents by a block, even when the contents to be selected on a read text are significantly long.

According to an aspect of the present invention, a method of selecting desired contents within text in a portable terminal is provided. The method includes determining a first position on a first row of the text; determining a second position on a second row of the text; and selecting contents located between the first position and the second position.

According to another aspect of the present invention, an apparatus for selecting desired contents within text in a portable terminal is provided. The apparatus includes an input for receiving user input; a display unit for displaying the text; and a controller for determining a first position on a first row of the text, determining a second position on a second row of the text, and selecting contents located between the first position and the second position.

According to another aspect of the present invention, a method of selecting desired portions of content in a portable terminal is provided. The method includes determining a first position on a first row of the content; determining a second position on a second row of the content; and selecting portions of the content located between the first position and the second position.

According to another aspect of the present invention, a portable terminal for selecting desired contents within text is provided. The portable terminal includes a memory; a processor; at least one module stored in the memory and configured for execution by the processor, the at least one module including instructions for determining a first position on a first row of the text, determining a second position on a second row of the text, and selecting contents located between the first position and the second position; and a touch screen for displaying the first position, the second position and the selected contents.

According to another aspect of the present invention, a portable terminal for selecting desired portions of content is provided. The portable terminal includes a memory; a processor; at least one module stored in the memory and configured for execution by the processor, the at least one module including instructions for determining a first position on a first row of the content, determining a second position on a second row of the content, and selecting portions of content located between the first position and the second position; and a touch screen for displaying the first position, the second position and the selected contents.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 is a block diagram of a touch screen terminal according to an embodiment of the present invention;

FIG. 2 is a flowchart illustrating a process of selecting desired contents on a read text in a portable terminal according to an embodiment of the present invention;

FIG. 3 is a diagram illustrating an example of screen displays for selecting desired contents on a webpage by a block according to an embodiment of the present invention;

FIG. 4 is a diagram illustrating an example of a screen display for selecting desired contents on an e-book by a block according to an embodiment of the present invention;

FIG. 5 is a diagram illustrating an example of a screen display for selecting desired contents on a text by a block according to an embodiment of the present invention; and

FIG. 6 is a diagram illustrating an example of a screen display for selecting desired contents on a webpage by a block according to an embodiment of the present invention.

### DETAILED DESCRIPTION OF EMBODIMENTS OF THE PRESENT INVENTION

Embodiments of the present invention are described herein below with reference to the accompanying drawings. In the following description, well-known functions or constructions may not be described in detail in order to avoid obscuring the invention in unnecessary detail. Also, the terms used herein are defined according to the functions of the present invention. That is, the terms used herein must be understood based on the descriptions made herein. Herein, with respect to numbered terms such as “first row” and “second row”, for example, the term “first row” is not limited to a first row in order at the beginning of the content, and similarly, “second row” is not limited to the row immediately following the row at the beginning of the content. Instead, “first row” and “second row” may refer to rows at other locations within the content, and the words “first” and “second” are merely used in order to identify each respective row with respect to the sequence of operations performed with the text. Accordingly, herein, the “first row” and the “second row” may refer to the same or different rows

Embodiments of the present invention described hereinafter relates to a portable terminal. Particularly, embodiments of the prevent invention relate to a method and apparatus for easily selecting desired contents on a text by a block. Embodiments of the prevent invention also relate to a method and apparatus for easily selecting desired contents on an image file by a block, and a method and apparatus for easily selecting, by a block, desired contents on a multimedia electronic file.

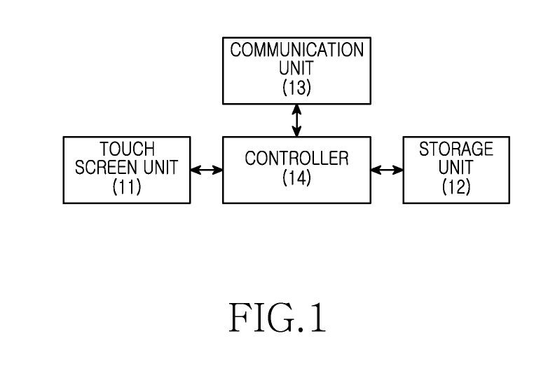

FIG. 1 is a block diagram of a touch screen terminal according to an embodiment of the present invention.

Referring to FIG. 1, the touch screen terminal according to an embodiment of the present invention includes a touch screen unit 11 for input and output, a storage unit 12 for storing data, a communication unit 13 for performing communication, and a controller 14 for controlling an overall operation. Although the present example refers to a touch screen unit 11 for providing input and output, other input and output devices may be used in accordance with embodiments of the present invention. Also, as an alternative, the input and output devices may be physically separate devices.

The touch screen unit 11, which is a touch-sensitive display, provides an input signal according to a touch of a user to the controller 14, and receives and displays display data corresponding to the input signal according to control of the controller 14. The input provided to the touch screen unit 11 may be according to one or more touches.

The storage unit 12, which may also be referred to as a memory, stores a program for controlling an overall operation of the touch screen terminal and a variety of data input and output when a control operation of the touch screen terminal is performed. The storage unit 12 includes at least one software module (not shown) that includes instructions for determining a first position on a first row of the text and determining a second position on a second row of the text, and selecting contents located between the first position and the second position may be included. The storage unit 12 also includes at least one software module (not shown) that includes instructions for determining a first position on a first row of the content and to determine a second position on a second row of the content, and selecting portions of the content located between the first position and the second position. The software modules are configured for execution by the controller 14. The software modules include instructions for selecting desired contents on a text or/and on an image file or/and on a multimedia electronic file by a block.

The controller 14 controls an overall operation of the touch screen terminal. Hereinafter, a method of selecting desired contents on a text according to an embodiment of the present invention in the controller 14 is described in detail with reference to drawings. The controller 14 may include one or more processors.

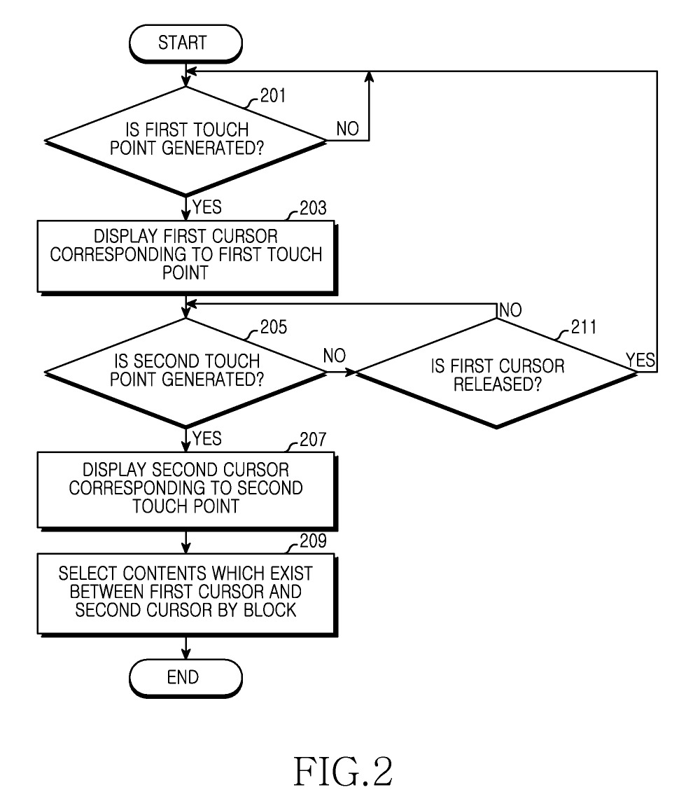

FIG. 2 is a flowchart illustrating a process of selecting desired contents on a read text in a portable terminal according to an embodiment of the present invention. The text includes contents with at least one row. For example, the text may be a webpage, an e-book, etc. Upon verification that a user is reading the text, the controller 14 provides a function for selecting desired contents within the text according to one embodiment of the present invention. Contents within an image file and/or an electronic multimedia file may also be selected in accordance with embodiments of the present invention.

Referring to FIG. 2, the controller 14 verifies whether a first touch point is generated, in step 201.

If the first touch point is generated, the controller 14 controls display of a first cursor corresponding to the first touch point in the touch screen unit 11, in step 203. The first cursor indicates a start position of contents to be specified by a block.

The controller 14 verifies whether a second touch point is generated, in step 205.

If the second touch point is generated, the controller 14 controls display of the second cursor corresponding to the second touch point on the touch screen unit 11, in step 209. The second cursor indicates an end position of the contents to be specified by the block. The controller 14 reverses colors of contents that exist between the first cursor and the second cursor, and selects the reversed contents via a block, in step 209.

However, if the second touch point is not generated, the controller 14 verifies whether the first cursor is released, in step 213. The first cursor may be released to re-determine a start position of contents to be specified by a block. For example, the first curser may be released when the user touches a blank area within a text. If the first touch point is released, the controller 14 returns to step 201. If the first touch point is not released, the controller 14 remains at steps 205 and 206 until a second touch point is generated or the first cursor is released.

According to some embodiments of the present invention, the method of FIG. 2 may further include a process of re-determining the first cursor or the second cursor (not shown). For example, such a process may include an event for selecting whether to maintain the first cursor corresponding to the first touch point or relocate the first cursor. Similarly, such a process may include an event for selecting whether to maintain the second cursor corresponding to the second touch point or relocate the second cursor.

A menu window for selecting functions capable of executing contents selected by a block may be provided through a pop-up display element. The functions in the pop-up display element may include a copy function, a storage function, etc.

According to another embodiment of the present invention, the first touch point and the second touch point may be simultaneously generated. For example, the user may simultaneously generate two touch points by using two fingers. At this time, a start position and an end position of a block corresponding to the respective touch points are determined. As described above, the touch points may be displayed as cursors. The range of contents selected by a block may be modified to a more accurate range through a process of moving either of the first and second touch points after they are initially generated.

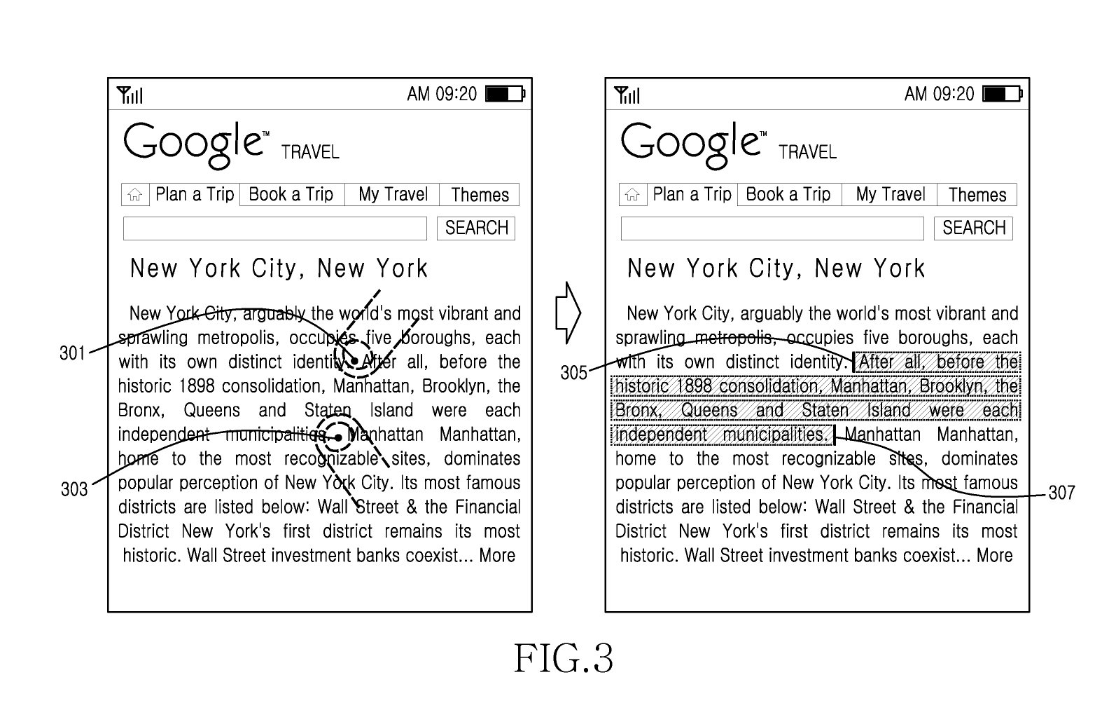

FIG. 3 is a diagram illustrating an example of screen displays for selecting desired contents on a webpage by a block according to one embodiment of the present invention.

Referring to FIG. 3, the webpage includes a text having contents with at least one row. If a user performs a first touch, a first touch point 301 is generated and a first cursor 305 corresponding to the first touch point 301 is displayed. The first cursor 305 indicates a start of a block. Also, as described above, the first cursor 305 may be moved after it is initially generated.

If the user performs a second touch, the second touch point 303 is generated and a second cursor 307 corresponding to the second touch point 303 is displayed. The second cursor 307 indicates an end of the block. A color of contents that exist between the first cursor 305 and the second cursor 307 is reversed and the reversed contents are selected by the block.

The contents selected by the block may be letters, words, or sentences, for example, according to a range of the first cursor 305 and the second cursor 307. As shown in FIG. 3, the contents included within at least one row may be selected by the block.

The cursors 305 and 307 corresponding to the touch points 301 and 303 may be displayed near or on letters that are closest to the touch points 301 and 303.

A menu window for selecting functions capable of executing the contents selected by the block may be displayed as a pop-up window. The functions within the menu window may include a copy function, a storage function, etc.

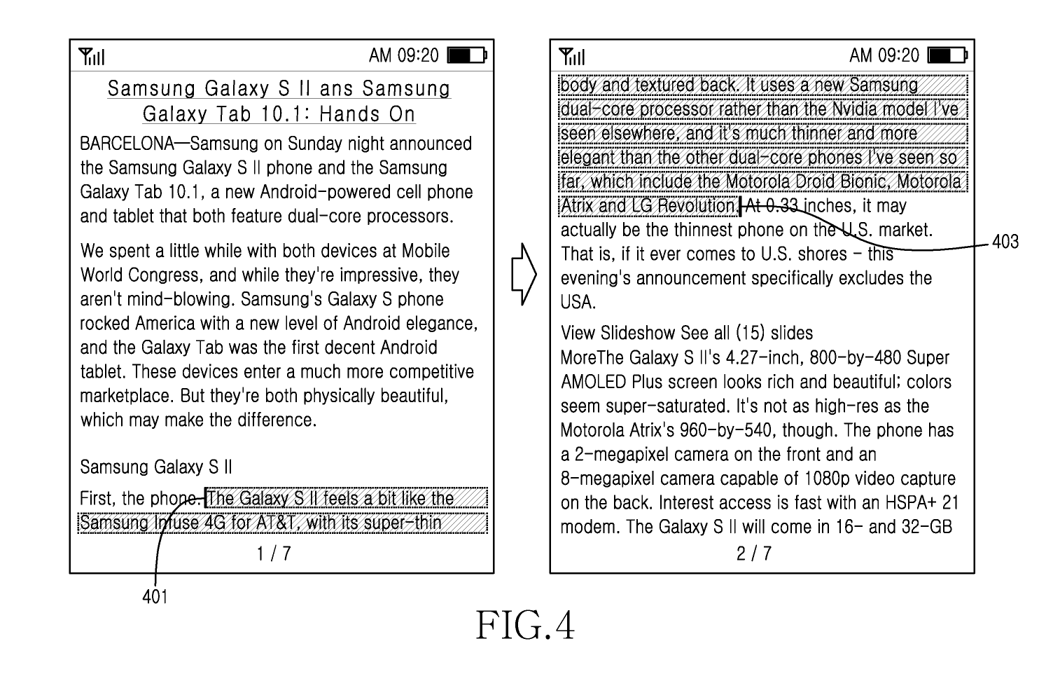

FIG. 4 is a diagram illustrating an example of screen displays for selecting desired contents on an e-book by a block according to an embodiment of the present invention.

Referring to FIG. 4, if a user performs a first touch, the first touch point is generated and a first cursor 401 corresponding to the first touch point is displayed. If the user turns from a currently-displayed page to a previous page or a next page and performs a second touch, the second touch point is generated. The second cursor 403 corresponding to the second touch point is displayed. Colors of contents that exist between the first cursor 401 and the second cursor 403 are reversed and the reversed contents are selected by a block, where the selection is unaffected by the page turning.

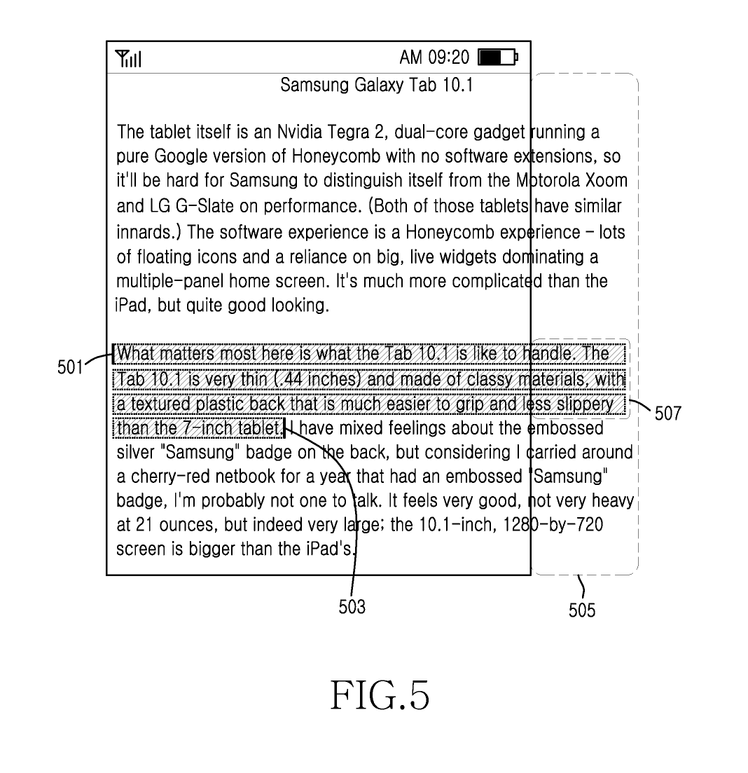

FIG. 5 is a diagram illustrating an example of a screen display for selecting desired contents on a text by a block according to an embodiment of the present invention.

Referring to FIG. 5, if a user performs a first touch, a first touch point is generated and a first cursor 501 corresponding to the first touch point is displayed. If the user performs a second touch, a second touch point is generated and a second cursor 503 corresponding to the second touch point is displayed. Colors of contents that exist between the first cursor 501 and the second cursor 503 are reversed and the reversed contents are specified by a block. Herein, there is a region 505 that is not currently displayed, but may be shown when the user scrolls or performs a zoom operation with respect to the text. Contents 507 exist between the first cursor 501 and the second cursor 503 and are included within the region 505 are not displayed. However, even though contents 507 are not currently displayed, since the contents 507 are included between the first cursor 501 and the second cursor 503, the contents 507 are also selected by the same block. A user may verify that the contents 507 are included within the block by scrolling or performing a zoom operation with respect to the text.

According to another embodiment of the present invention, the text selected by the block may only include a displayed part of the contents existing between the first cursor 501 and the second cursor 503, while excluding contents 507 included within the region 505.

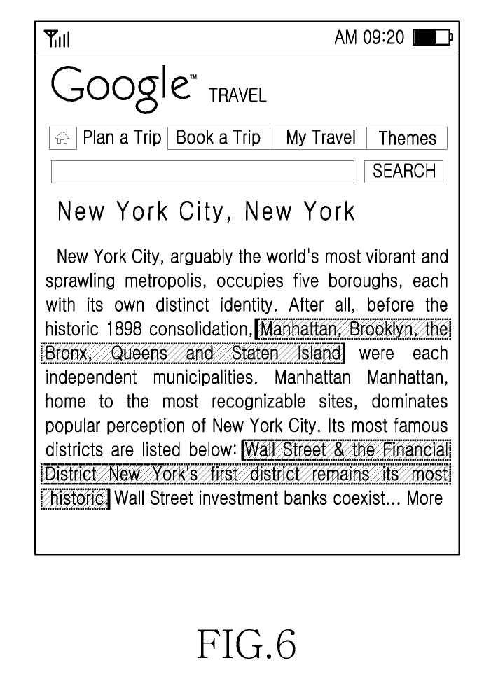

FIG. 6 is a diagram illustrating a picture for selecting desired contents on a webpage by a block according to one embodiment of the present invention.

Referring to FIG. 6, a plurality of separated contents within a text may be selected by multiple blocks according to the operations described hereinabove according to embodiments of the present invention. For example, after a first block is selected, additional blocks may be selected by using any of the above-described operations for selecting a first block.

Although embodiments of the present invention are described above with reference to a touch screen terminal, the present invention is not limited to the touch screen terminal. More specifically, other forms of input, such as a mouse and a keypad, may be applied to a terminal in accordance with embodiments of the present invention. For example, if a user performs a first click using the mouse, a start position corresponding to a first point is determined. If the user performs a second click using the mouse, an end position of the block corresponding to a second point is determined. In this manner, the block is specified according to the respective positions corresponding to the first and second mouse clicks.

Although embodiments of the present invention are described above with reference to contents selected from within text, the present invention is not limited to such a selection. More specifically, contents within other types of data such as an image file and/or an electronic multimedia file may also be selected in accordance with embodiments of the present invention.

As described herein, according to embodiments of the prevent invention, a user may easily select desired contents within a read text in a portable terminal. While the present invention has been particularly shown and described with reference to certain embodiments thereof, it will be understood by those skilled in the art that various changes in form and details may be made therein without departing from the spirit and scope of the present invention as defined by the appended claims.

What is claimed is:

1. A method of selecting desired contents within text in a portable terminal, the method comprising:
determining a first position on a first row of the text;
determining a second position on a second row of the text; and
selecting contents located between the first position and the second position.

2. The method of claim 1, further comprising re-determining at least one of the first position and the second position again.

3. The method of claim 1, further comprising displaying the contents located between the first position and the second position within a block having colors reversed according to a default reverse color scheme.

4. The method of claim 1, wherein the selected contents located between the first position and the second position exclude any contents not currently displayed at a time the contents are selected.

5. The method of claim 1, wherein the first row and the second row exist on different pages.

6. A portable terminal including for selecting desired contents within text, the portable terminal comprising:
a display unit for displaying the text; and
a controller for determining a first position on a first row of the text, determining a second position on a second row of the text, and selecting contents located between the first position and the second position.

7. The portable terminal of claim 6, wherein if the controller re-determines at least one of the first position and the second position, the controller re-selects contents according to the re-determined at least one of the first position and the second position.

8. The portable terminal of claim 6, wherein the controller controls display of the contents located between the first position and the second position within a block having colors reversed according a default reverse color scheme.

9. The portable terminal of claim 6, wherein the selected contents located between the first position and the second position exclude any contents not currently displayed at a time the contents are selected.

10. The portable terminal of claim 6, wherein the first row and the second row exist on different pages.

11. A method of selecting desired portions of content in a portable terminal, the method comprising:
determining a first position on a first row of the content;
determining a second position on a second row of the content; and
selecting portions of the content located between the first position and the second position.

12. The method of claim 11, further comprising re-determining at least one of the first position and the second position.

13. The method of claim 11, further comprising displaying the contents located between the first position and the second position within a block having colors reversed according to a default reverse color scheme.

14. The method of claim 11, wherein the selected contents located between the first position and the second position exclude any contents not currently displayed at a time the contents are selected.

15. A portable terminal for selecting desired contents within text, comprising:
a memory;
a processor;
at least one module stored in the memory and configured for execution by the processor, the at least one module including instructions for determining a first position on a first row of the text, determining a second position on a second row of the text, and selecting contents located between the first position and the second position; and
a touch screen for displaying the first position, the second position and the selected contents.

16. The portable terminal of claim 15, wherein the at least one module further includes instructions for re-determining at least one of the first position and the second position.

17. The portable terminal of claim 15, wherein the at least one module further includes instructions for displaying the contents located between the first position and the second position within a block having colors reversed according to a default reverse color scheme.

18. The portable terminal of claim 15, wherein the selected contents located between the first position and the second position exclude any contents not currently displayed at a time the contents are selected.

19. A portable terminal for selecting desired portions of content comprising:
a memory;
a processor;
at least one module stored in the memory and configured for execution by the processor, the at least one module including instructions for determining a first position on a first row of the content, determining a second position on a second row of the content, and selecting portions of content located between the first position and the second position; and
a touch screen for displaying the first position, the second position and the selected contents.

20. The portable terminal of claim 19, wherein the at least one module further includes instructions for re-determining at least one of the first position and the second position.
